(19) United States
(12) Patent Application Publication
(10) Pub. No.: US 2026/0310617 A1
(43) Pub. Date: Oct. 8, 2026

(54) DEVICE, SYSTEM AND METHODS FOR DATA MANAGEMENT OF A CIRCULAR BUFFER

(71) Applicant: Microchip Technology Inc., Chandler, AZ (US)

(72) Inventors: Yong Yuenyongsgool, Gilbert, AZ (US); Andreas Reiter, Feldkirchen-Westerham (DE); Stephen Bowling, Chandler, AZ (US); Tim James Phoenix, Pepperell, MA (US)

(73) Assignee: Microchip Technology Inc., Chandler, AZ (US)

(21) Appl. No.: 19/328,382

(22) Filed: Sep. 15, 2025

Related U.S. Application Data
(60) Provisional application No. 63/782,753, filed on Apr. 3, 2025.

(51) Int. Cl. G06F 13/28; G06F 13/24

(52) U.S. Cl. CPC G06F 13/28; G06F 13/24

(57) ABSTRACT

A system includes multiple bus initiators coupled to a buffer. The buffer may be configured as one or more circular buffers. In operation, a first bus initiator may write data to the circular buffer at a head pointer location, and a second bus initiator may read data from the circular buffer at a tail pointer location. At least one bus initiator may compute an overflow condition based on the head pointer and the tail pointer. At least one bus initiator may compute an underflow condition based on the head pointer and the tail pointer. The system may enable seamless data transmission from multiple bus initiators sharing a single buffer.

### PRIORITY

This application claims priority to commonly owned US Provisional Patent Application 63/782,753 filed on Apr. 3, 2025, the entire contents of which are hereby incorporated by reference for all purposes.

### FIELD OF THE INVENTION

The present disclosure relates to a device, system and method for data management in a circular buffer, more specifically to a circular buffer configured as a first-in-first-out memory (FIFO).

### BACKGROUND

In modern digital systems, it is common for multiple bus initiators—such as processors, direct memory access (DMA) controllers, and peripheral interfaces—to transmit data to a shared destination, such as a first-in, first-out (FIFO) memory. FIFOs are widely used to decouple data producers and consumers operating at different clock domains or data rates. Efficient and reliable arbitration among multiple initiators attempting to write to the same FIFO may maintain data integrity and system throughput.

Conventional FIFO management schemes typically rely on fixed-priority arbitration or round-robin logic to control access. While such techniques can provide fairness or determinism, they often fail to adapt to varying workloads, dynamic priorities, or contention scenarios. Such techniques may require sharing of system memory, which is an inefficient use of system memory. Such solutions may also utilize significant system bandwidth and computing overhead in the management of data between bus initiators and memory endpoints. Solutions may require individual memory elements for bus initiators, which results in inefficient use of memory and computing resources.

Additionally, they may introduce unnecessary latency or complexity, particularly in systems with tightly constrained timing or power budgets.

As system architectures grow more heterogeneous and bandwidth demands increase, the need arises for improved mechanisms to coordinate writes from multiple initiators to a shared FIFO. These mechanisms should ensure orderly and lossless data transfer while supporting scalability, low latency, and compatibility with a range of bus protocols and timing domains.

There is a need for devices, systems and methods to orderly and reliably share a single allocated memory space among multiple bus initiators.

### SUMMARY

The examples herein enable devices, systems and methods for initialization of configurable logic blocks.

According to one aspect, a device includes a first bus initiator coupled to a peripheral, wherein the first bus initiator comprises a data buffer, a head pointer register and a tail pointer register, the data buffer to receive a data stream from the peripheral. The device includes a non-transitory memory coupled to the first bus initiator and configured as a circular buffer, and a second bus initiator coupled to an output of the non-transitory memory. The first bus initiator may write data from the data buffer to the non-transitory memory at a memory location specified by a content of the head pointer register and the second bus initiator may read data from the non-transitory memory at a memory location specified by a content of the tail pointer register.

Aspects as in the preceding paragraph provide a device, wherein the first bus initiator comprises a first direct memory access (DMA) channel configured by a DMA controller.

Aspects as in at least one of the two preceding paragraphs provide a device, the device as claimed in claim 2, wherein the second bus initiator comprises a second DMA channel configured by the DMA controller.

Aspects as in at least one of the three preceding paragraphs provide a device, wherein the second bus initiator comprises a central processing unit (CPU).

Aspects as in at least one of the four preceding paragraphs provide a device, wherein the first bus initiator is to compute an amount of data in the circular buffer based on the content of the head pointer register and the content of the tail pointer register.

Aspects as in at least one of the five preceding paragraphs provide a device, wherein the first bus initiator is to compute one or more overflow conditions based on the content of the head pointer register and the content of the tail pointer register, the one or more overflow conditions comprising at least one of an overflow alert and an overflow warning.

Aspects as in at least at least one of the six preceding paragraphs provide a device, wherein the first bus initiator is to generate an interrupt signal based on the overflow condition.

Aspects as in at least one of the seven preceding paragraphs provide a device, wherein the first bus initiator is to compute an underflow condition based on a content of the head pointer register and a content of the tail pointer register.

Aspects as in at least one of the eight preceding paragraphs provide a device, wherein the first bus initiator is to generate an interrupt signal based on the underflow condition.

Aspects as in at least one of the nine preceding paragraphs provide a device, wherein the second bus initiator is to write data to the non-transitory memory at the location specified by a content of the head pointer register and the first bus initiator to read data from the non-transitory memory at the location specified by a content of the tail pointer register.

Aspects as in at least one of the ten preceding paragraphs provide a device, wherein the second bus initiator is to update a content of at least one of the head pointer register and the tail pointer register.

Aspects as in at least one of the eleven preceding paragraphs provide a device, comprising a bus snooper circuit coupled to an output of the non-transitory memory, the bus snooper circuit to update a content of the tail pointer register based on the output of the non-transitory memory.

Aspects provide a system, wherein a direct memory access (DMA) controller to receive a digital data stream, the DMA controller comprising a receive data buffer and a transmit data buffer. The system includes a non-transitory memory coupled to the DMA controller comprising: a receive circular buffer and transmit circular buffer. The system includes a bus initiator to read data from the receive circular buffer at a location specified by a content of a receive tail pointer register and to write data to the transmit circular buffer at a location specified by a content of a transmit head pointer register. In operation the direct memory access (DMA) controller to write data from the receive data buffer to the receive circular buffer at a location specified by a content of a receive head pointer register and to read data from the transmit circular buffer at a location specified by a content of a transmit tail pointer register.

Aspects as in the preceding paragraph provide a system, wherein the DMA controller to transfer data to and from the receive circular buffer and to transfer data to and from the transmit circular buffer.

Aspects as in at least one of the two preceding paragraphs provide a system, wherein the DMA controller is to compute at least one receive overflow condition and at least one receive underflow condition based on a content of the receive head pointer register and a content of the receive tail pointer register, the at least one receive overflow condition comprising at least one of a receive overflow alert and a receive overflow warning, and the at least one receive underflow condition comprising at least one of a receive underflow alert and a receive underflow warning.

Aspects as in at least one of the three preceding paragraphs provide a system, wherein the DMA controller is to compute at least one transmit overflow condition and at least one transmit underflow condition based on a content of the transmit head pointer register and a content of the transmit tail pointer register, the at least one transmit overflow condition comprising at least one of a transmit overflow alert and a transmit overflow warning, and the at least one transmit underflow condition comprising at least one of a transmit underflow alert and a transmit underflow warning.

According to one aspect, a method includes: configuring a non-transitory memory as a circular buffer, writing data from a peripheral to a first bus initiator and writing the data from the first bus initiator to the circular buffer, at a location specified by a content of a head pointer register, reading, by a second bus initiator, data from the circular buffer at a location specified by a content of a tail pointer register, updating, by the second bus initiator, a content of the tail pointer register, and calculating, by the first bus initiator, an overflow condition and an underflow condition based on a content of the tail pointer register and a content of the head pointer register.

Aspects as in the preceding paragraph provide a method, wherein the first bus initiator comprises a first direct memory access (DMA) channel configured by a DMA controller.

Aspects as in at least one of the two preceding paragraphs provide a method, wherein the second bus initiator comprises a second DMA channel configured by the DMA controller.

Aspects as in at least one of the three preceding paragraphs provide a method, wherein the second bus initiator comprises a central processing unit (CPU).

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 illustrates a block diagram of a system for receiving data at a central processing unit (CPU) utilizing a circular FIFO.

FIG. 2 illustrates a block diagram of a system for transmitting data from a CPU utilizing a circular FIFO.

FIG. 3 illustrates a block diagram of a system for a receive and transmit data operation at different sample rates and data formats utilizing multiple circular FIFOs.

FIG. 4 illustrates one of various examples of a system for peer-to-peer data transmission via DMA channels utilizing a circular FIFO.

FIG. 5 illustrates a block diagram of a system for peer-to-peer-to-peer data transmission utilizing multiple circular FIFOs.

FIG. 6 illustrates a block diagram of a system for a receive and transmit DMA data operation in a data acquisition application utilizing one or more circular FIFOs.

FIG. 7 illustrates a block diagram of a system to receive and transmit DMA data operation in a secure boot application utilizing one or more circular FIFOs.

FIG. 8 illustrates a block diagram of a system to receive and transmit DMA data operation in a real-time control system application utilizing one or more circular FIFOs.

FIG. 9 illustrates a flow chart of a method of data management in a circular FIFO in hardware and software.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DETAILED DESCRIPTION

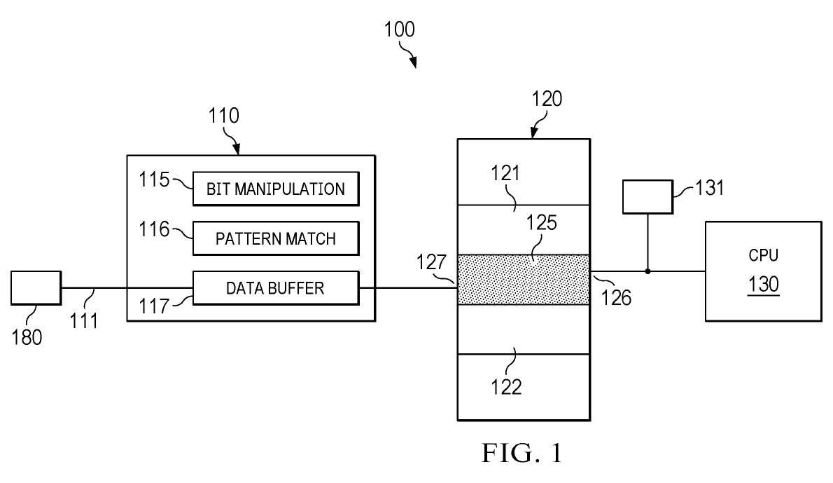

FIG. 1 illustrates a block diagram of a system 100 for receiving data at a central processing unit (CPU) utilizing a circular FIFO to manage dataflow. System 100 may include DMA controller 110, buffer 120 and CPU 130. Buffer 120 may be a non-transitory memory. In the example illustrated in FIG. 1, buffer 120 may be configured as a circular FIFO.

DMA controller 110 may include a bit manipulation circuit 115, a pattern match circuit 116 and a data buffer 117. In operation, peripheral 180 may write data to data buffer 117 via path 111. DMA controller 110 may be a bus initiator and may initiate transfer of data from peripheral 180. Peripheral 180 may generate a digital data stream.

Buffer 120 may be configured as a circular buffer between a first location 121 and a second location 122. The size of the circular buffer shown in FIG. 1 is for illustrative purposes and should not be taken as limiting. Buffer 120 may be coupled to DMA controller 110 and may be coupled to CPU 130. CPU 130 may be a bus initiator and may initiate transfer of data from buffer 120.

In operation, peripheral 180 may write data to data buffer 117 in DMA controller 110 via path 111. Peripheral 180 may be implemented as any suitable hardware or functional module operably coupled to or integrated within the microcontroller and configured to perform a specific input/output, control, or communication function. Examples of peripheral 180 may include, but are not limited to, communication interfaces such as Universal Asynchronous Receiver-Transmitter (UART), Serial Peripheral Interface (SPI), Inter-Integrated Circuit (I²C), Controller Area Network (CAN), or Universal Serial Bus (USB) modules; timing components such as timers, counters, or pulse-width modulation (PWM) units; analog interfaces such as analog-to-digital converters (ADCs) or digital-to-analog converters (DACs); and control interfaces for external devices such as motor drivers, display controllers, or general-purpose input/output (GPIO) ports.

In operation, DMA controller 110 may read data from peripheral 180 to data buffer 117 in DMA controller 110 via path 111. Peripheral 180 may be implemented as any suitable hardware or functional module operably coupled to or integrated within the microcontroller and configured to perform a specific input/output, control, or communication function. Examples of peripheral 180 may include, but are not limited to, communication interfaces such as Universal Asynchronous Receiver-Transmitter (UART), Serial Peripheral Interface (SPI), Inter-Integrated Circuit (I²C), Controller Area Network (CAN), or Universal Serial Bus (USB) modules; timing components such as timers, counters, or pulse-width modulation (PWM) units; analog interfaces such as analog-to-digital converters (ADCs) or digital-to-analog converters (DACs); and control interfaces for external devices such as motor drivers, display controllers, or general-purpose input/output (GPIO) ports.

DMA controller 110 may include logic and other circuitry to track a head pointer 127. Head pointer 127 may contain the memory content within buffer 120 where DMA controller 110 may write the next data word from data buffer 117. Head pointer 127 may be stored in a head pointer register. CPU 130 may include logic and other circuitry to track a tail pointer 126. Tail pointer 126 may contain the memory location within buffer 120 where CPU 130 may read the next data word from buffer 120. Tail pointer 126 may be stored in a tail pointer register located in DMA controller 110.

In operation, DMA controller 110 may write data from data buffer 117 to buffer 120, at the memory location specified by a content of head pointer 127. CPU 130 may read data from buffer 120 at the memory location specified by a content of tail pointer 126. DMA controller 110 may not be involved in the reading of data from buffer 120 by CPU 130. The region between the head pointer and the tail pointer may indicate valid data, indicated by region 125 in FIG. 1.

DMA controller 110 may determine an overflow alert, defined as when head pointer 127 catches up to tail pointer 126. DMA controller 110 may additionally determine one or more overflow warnings in advance of an overflow alert. As one of various examples, DMA controller 110 may define a “four locations remaining” overflow warning when only four memory locations are available before an overflow alert would be triggered. The “four locations remaining” overflow warning is not intended to be limiting, and an overflow warning may be determined based on another numerical value of locations remaining. Collectively, the overflow alert and overflow warnings may be termed overflow conditions. DMA controller 110 may determine one or more overflow conditions.

During conditions of an overflow alert, DMA controller 110 may write new data at the location indicated by head pointer 127 and overwrite data in buffer 120. DMA controller 110 may output the overflow condition to CPU 130 or other components in system 100 to prevent overwriting data. The overflow condition may be output as an interrupt signal.

DMA controller 110 may determine an underflow alert when tail pointer 126 catches up to head pointer 127. DMA controller 110 may additionally determine one or more underflow warnings in advance of an underflow alert. As one of various examples, DMA controller 110 may define a “four locations remaining” underflow warning when only four memory locations are available to be read before an underflow alert would be triggered. The “four locations remaining” underflow warning is not intended to be limiting, and an underflow warning may be determined based on another numerical value of locations remaining.

During conditions of an underflow alert, CPU 130 may read data at the location indicated by tail pointer 126 before DMA controller 110 had written new data to buffer 120. DMA controller 110 may output the underflow condition to CPU 130 or other components in system 100 to prevent the reading of erroneous data. The underflow condition may be output as an interrupt signal. Circuitry at 131 may monitor data from buffer 120 to CPU 130 and may write data to DMA controller 110 to indicate a location of tail pointer 126. Circuitry at 131 may be termed a bus snooper circuit and may monitor bus traffic between buffer 120 and CPU 130. DMA controller 110 may compute an amount of data in buffer 120 based on head pointer 127 and tail pointer 126. CPU 130 may not update tail pointer 126 if the bus snooper circuit monitors bus traffic.

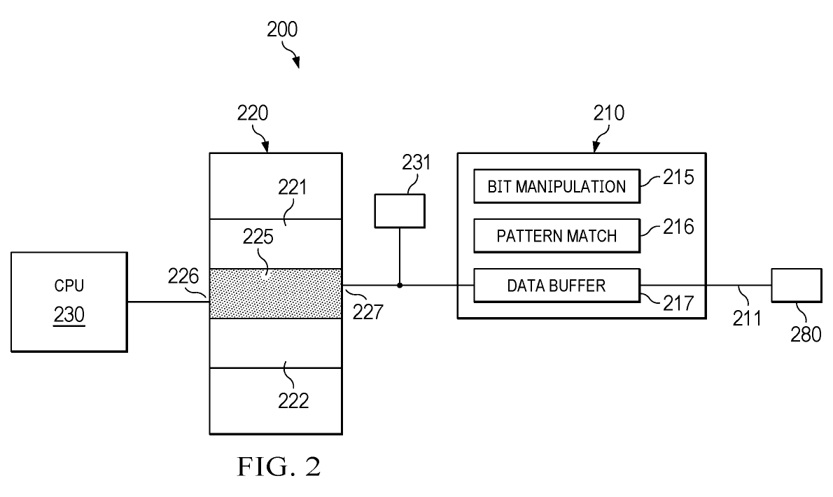

FIG. 2 illustrates a block diagram of a system 200 for transmitting data from a CPU utilizing a circular FIFO. System 200 may include DMA controller 210, buffer 220 and CPU 230. buffer 220 may be a non-transitory memory. CPU 230 may be a bus initiator and may initiate transfer of data from buffer 220.

DMA controller 210 may include bit manipulation circuit 215, pattern match circuit 216 and data buffer 217. In operation, DMA controller 210 may write data to peripheral 280 from data buffer 217 via path 211. DMA controller 210 may be a bus initiator and may initiate transfer of data to peripheral 280. Peripheral 280 may receive a digital data stream.

Buffer 220 may be configured as a circular FIFO between a first location 221 and a second location 222. For purposes of this disclosure, buffer 220 may also be referred to as buffer 220. The size of the circular buffer shown in FIG. 2 is for illustrative purposes and should not be taken as limiting. Buffer 220 may be coupled to DMA controller 210 and may be coupled to CPU 230.

CPU 230 may include logic and other circuitry to track a head pointer 226. Head pointer 226 may contain the location that DMA controller 210 may write the next data word from data buffer 217. Head pointer 226 may be stored in a head pointer register. DMA controller 210 may include logic and other circuitry to track a tail pointer 227. Tail pointer 227 may contain the location that DMA controller 210 may read the next data word from buffer 220. Tail pointer 227 may be stored in a tail pointer register.

In operation, CPU 230 may write data to buffer 220 at the location specified by a content of head pointer 226. DMA controller 210 may read the data from buffer 220, at the location specified by a content of tail pointer 227. DMA controller 210 may not be involved in the writing of data from CPU 230 to buffer 220. The region between head pointer 226 and tail pointer 227 may indicate valid data and is indicated by region 225 in FIG. 2.

DMA controller 210 may determine an overflow alert when the head pointer 226 catches up to the tail pointer 227. DMA controller 210 may additionally determine one or more overflow warnings in advance of an overflow alert. As one of various examples, DMA controller 210 may define a “four locations remaining” overflow warning when only four memory locations are available before an overflow alert would be triggered. The “four locations remaining” overflow warning is not intended to be limiting, and an overflow warning may be determined based on another numerical value of locations remaining. Collectively, the overflow alert and overflow warnings may be termed overflow conditions. DMA controller 210 may determine one or more overflow conditions.

During conditions of an overflow alert, CPU 230 may write new data at the location indicated by head pointer 226 and overwrite data in buffer 220. DMA controller 210 may output the overflow condition to CPU 230 or other components in system 200 to prevent overwriting data. The overflow condition may be output as an interrupt signal.

DMA controller 210 may determine an underflow alert when the tail pointer 227 catches up to the head pointer 226. DMA controller 210 may additionally determine one or more underflow warnings in advance of an underflow alert. As one of various examples, DMA controller 210 may define a “four locations remaining” underflow warning when only four memory locations are available to be read before an underflow alert would be triggered. The “four locations remaining” underflow warning is not intended to be limiting, and an underflow warning may be determined based on another numerical value of locations remaining.

During conditions of an underflow alert, DMA controller 210 may read data at the location indicated by tail pointer 227 before CPU 230 had written new data to buffer 220. DMA controller 210 may output the underflow condition to CPU 230 or other components in system 200 to prevent the reading of erroneous data. The underflow condition may be output as an interrupt signal. Circuitry at 231 may monitor data from buffer 220 to DMA controller 210 and may write data to CPU 230 to indicate a location of tail pointer 227. Circuitry at 231 may be termed a bus snooper circuit and may monitor bus traffic between buffer 220 and DMA controller 210. The bus snooper circuit may monitor data transfer of data from CPU 230 to buffer 220 and may update the head pointer 226 in DMA controller 210. DMA controller 210 may compute an amount of data in buffer 120 based on head pointer 226 and tail pointer 227.

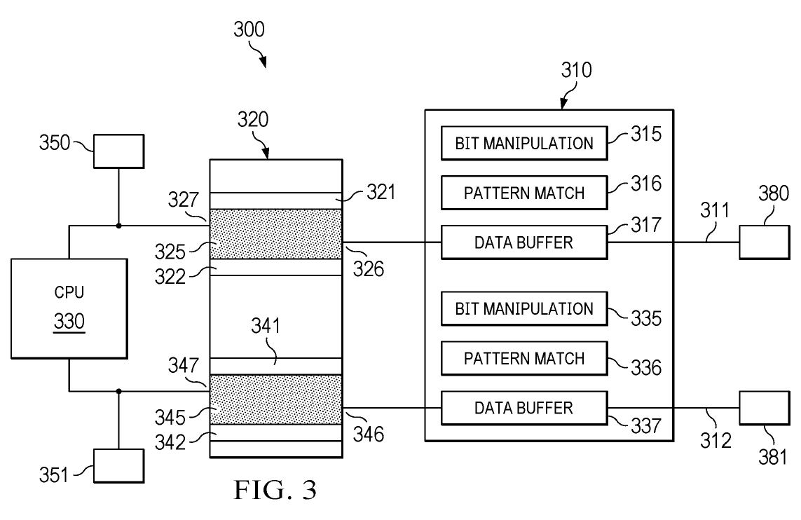

FIG. 3 illustrates a block diagram of a system for a receive and transmit data operation at different sample rates and data formats utilizing multiple circular FIFOs.

System 300 may include a receive path from peripheral 380 to CPU 330 via path 311 and DMA controller 310, and a transmit path from CPU 330 to peripheral 381 via DMA controller 310 path 312. System 300 may include DMA controller 310, buffer 320 and CPU 330. CPU 330 may be a bus initiator and may initiate transfer of data to and from buffer 320. Peripheral 380 may generate a digital data stream.

DMA controller 310 may include receive circuitry and transmit circuitry. DMA controller 310 may control transfer of data between peripheral 380 and buffer 320 and between buffer 320 and peripheral 381. The receive circuitry of DMA controller 310 may include first bit manipulation circuit 315, a first pattern match circuit 316, and receive data buffer 317. In operation, peripheral 380 may write data to the receive data buffer 317 via path 311. DMA controller 310 may be a bus initiator and may initiate transfer of data from peripheral 380 and to peripheral 381.

The transmit circuitry of DMA controller 310 may include a second bit manipulation circuit 335, a second pattern match circuit 336 and a transmit data buffer 337. In operation, DMA controller 310 may write data from transmit data buffer 337 to a peripheral 381 via path 312.

Buffer 320 may be configured as one or more circular buffers. A receive circular buffer may be configured between a first location 321 and a second location 322. A transmit circular buffer may be configured between a third location 341 and a fourth location 342. The size of the circular buffers shown in FIG. 3 is for illustrative purposes and should not be taken as limiting. Buffer 320 may be coupled to DMA controller 310 and may be coupled to CPU 330.

DMA controller 310 may include logic and other circuitry to track a receive head pointer 326. Receive head pointer 326 may contain the location that DMA controller 310 may write the next data word from receive data buffer 317. Receive head pointer 326 may be stored in a receive head pointer register. DMA controller 310 may include logic and other circuitry to track a receive tail pointer 327. Receive tail pointer 327 may contain the location that CPU 330 may read the next data word from buffer 320. Receive tail pointer 327 may be stored in a receive tail pointer register. DMA controller 310 may compute an amount of data in buffer 320 based on receive head pointer 326 and receive tail pointer 327. The region between receive head pointer 326 and receive tail pointer 327 may indicate valid data and is indicated by region 325 in FIG. 3.

DMA controller 310 may include logic and other circuitry to track a transmit head pointer 347. Transmit head pointer 347 may contain the location that CPU 330 may write the next data word to buffer 320. Transmit head pointer 347 may be stored in a receive head pointer register. DMA controller 310 may include logic and other circuitry to track a transmit tail pointer 346. Transmit tail pointer 346 may contain the location that DMA controller 310 may read the next data word from buffer 320. Transmit tail pointer 346 may be stored in a receive tail pointer register. DMA controller 310 may compute an amount of data in buffer 320 based on transmit head pointer 347 and transmit tail pointer 346.

DMA controller 310 may determine an overflow alert when receive head pointer 326 catches up to receive tail pointer 327. DMA controller 310 may additionally determine one or more overflow warnings in advance of an overflow alert. As one of various examples, DMA controller 310 may define a “four locations remaining” overflow warning when only four memory locations are available before an overflow alert would be triggered. The “four locations remaining” overflow warning is not intended to be limiting, and an overflow warning may be determined based on another numerical value of locations remaining. Collectively, the overflow alert and overflow warnings may be termed overflow conditions. DMA controller 310 may determine one or more overflow conditions.

During conditions of an overflow alert, DMA controller 310 may write new data at the location indicated by receive head pointer 326 and overwrite data in buffer 320. DMA controller 310 may output the overflow condition to CPU 330 or other components in system 300 to prevent overwriting data. The overflow condition may be output as an interrupt signal.

DMA controller 310 may determine an underflow alert when receive tail pointer 327 catches up to receive head pointer 326. DMA controller 310 may additionally determine one or more underflow warnings in advance of an underflow alert. As one of various examples, DMA controller 310 may define a “four locations remaining” underflow warning when only four memory locations are available to be read before an underflow alert would be triggered. The “four locations remaining” underflow warning is not intended to be limiting, and an underflow warning may be determined based on another numerical value of locations remaining.

During conditions of an underflow alert, CPU 330 may read data at the location indicated by receive tail pointer 327 before DMA controller 310 had written new data to buffer 320. DMA controller 310 may output the underflow condition to CPU 330 or other components in system 300 to prevent the reading of erroneous data. The underflow condition may be output as an interrupt signal. Circuitry at 350 may monitor data from buffer 320 to CPU 330 and may write data to DMA controller 310 to indicate a location of receive tail pointer 327. Circuitry at 350 may be termed a bus snooper circuit and may monitor bus traffic between buffer 320 and CPU 330.

DMA controller 310 may determine an overflow condition when transmit head pointer 347 catches up to transmit tail pointer 346. The overflow condition may be an overflow alert or an overflow warning. During conditions of an overflow alert, CPU 330 may write new data at the location indicated by transmit head pointer 347 and overwrite data in buffer 320. DMA controller 310 may output the overflow condition to CPU 330 or other components in system 300 to prevent overwriting data. The overflow condition may be output as an interrupt signal.

DMA controller 310 may determine an underflow condition when transmit tail pointer 346 catches up to transmit head pointer 347. The underflow condition mya be an underflow alert or an underflow warning. During conditions of an underflow alert, DMA controller 310 may read data at the location indicated by transmit tail pointer 346 before CPU 330 had written new data to buffer 320. DMA controller 310 may output the underflow condition to CPU 330 or other components in system 300 to prevent the reading of erroneous data. The underflow condition may be output as an interrupt signal. Circuitry at 351 may monitor data from CPU 330 to buffer 320 and may write data to DMA controller 310 to indicate a location of transmit head pointer 347. Circuitry at 351 may be termed a bus snooper circuit and may monitor bus traffic between buffer 320 and CPU 330.

In operation, CPU 330 may write data to buffer 320 at the location specified by transmit head pointer 347. DMA controller 310 may read the data from buffer 320, at the location specified by transmit tail pointer 346. DMA controller 310 may not be involved in the writing of data from CPU 330 to buffer 320. The region between transmit head pointer 347 and transmit tail pointer 346 may indicate valid data and is indicated by region 345 in FIG. 3.

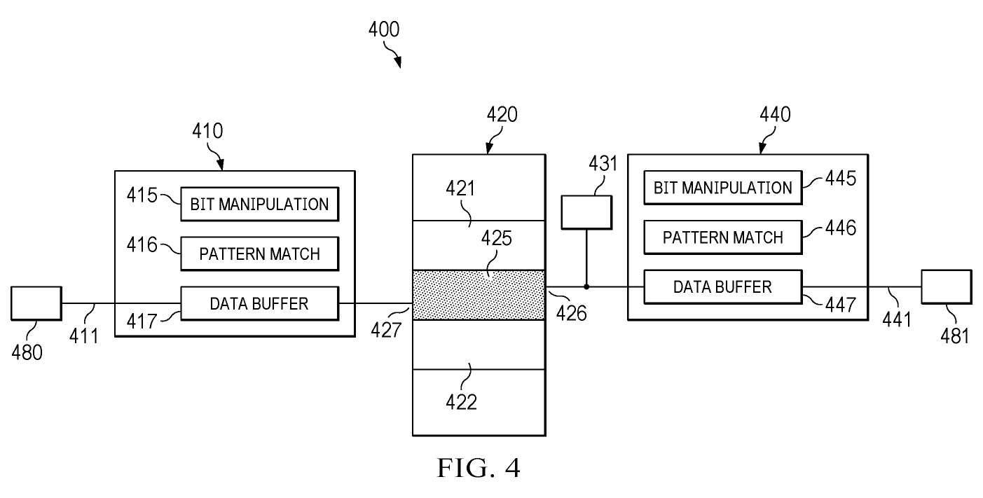

FIG. 4 illustrates one of various examples of a system for peer-to-peer data transmission via DMA channels utilizing a circular FIFO.

System 400 may include a first DMA channel 410, a second DMA channel 440 and buffer 420. Buffer 420 may be a non-transitory memory. Buffer 420 may be configured as one or more circular FIFOs.

First DMA channel 410 may include bit manipulation circuit 415, pattern match circuit 416 and receive data buffer 417. In operation, peripheral 480 may write data to receive data buffer 417 via path 411. First DMA channel 410 may be a bus initiator and may initiate transfer of data to and from buffer 420. Peripheral 480 may generate a digital data stream.

Second DMA channel 440 may include bit manipulation circuit 445, pattern match circuit 446 and transmit data buffer 447. In operation, peripheral 481 may receive data from transmit data buffer 447 via path 441. Second DMA channel 440 may be a bus initiator and may initiate transfer of data to and from buffer 420.

Buffer 420 may be configured as a circular FIFO between a first location 421 and a second location 422. The size of the circular buffer shown in FIG. 4 is for illustrative purposes and should not be taken as limiting. Buffer 420 may be coupled to first DMA channel 410 and may be coupled to second DMA channel 440.

First DMA channel 410 may include logic and other circuitry to track a head pointer 427. Head pointer 427 may contain the location that first DMA channel 410 may write the next data word from data buffer 417. Head pointer 427 may be stored in a head pointer register. First DMA channel 410 may include logic and other circuitry to track a tail pointer 426. Tail pointer 426 may contain the location that second DMA channel 440 may read the next data word from buffer 420. Tail pointer 426 may be stored in a tail pointer register.

Second DMA channel 440 may include logic and other circuitry to track a tail pointer 426. Head pointer 427 may contain the location that first DMA channel 410 may write the next data word from data buffer 417. Head pointer 427 may be stored in a head pointer register. Second DMA channel 440 may include logic and other circuitry to track a tail pointer 426. Tail pointer 426 may contain the location that second DMA channel 440 may read the next data word from buffer 420. Tail pointer 426 may be stored in a tail pointer register.

In operation, peripheral 480 may write data to receive data buffer 417 in first DMA channel 410 via path 411. First DMA channel 410 may write the data from receive data buffer 417 to buffer 420, at the location specified by a content of head pointer 427. Second DMA channel 440 may read data from buffer 420 at the location specified by a content of tail pointer 426. The region between head pointer 427 and tail pointer 426 may indicate valid data, as shown by region 425 in FIG. 4.

First DMA channel 410 and second DMA channel 440 may be part of a single DMA controller circuit.

First DMA channel 410 may determine an overflow alert when head pointer 427 catches up to tail pointer 426. First DMA channel 410 may additionally determine one or more overflow warnings in advance of an overflow alert. As one of various examples, first DMA channel 410 may define a “four locations remaining” overflow warning when only four memory locations are available before an overflow alert would be triggered. The “four locations remaining” overflow warning is not intended to be limiting, and an overflow warning may be determined based on another numerical value of locations remaining. Collectively, the overflow alert and overflow warnings may be termed overflow conditions. First DMA channel 410 may determine one or more overflow conditions.

During conditions of an overflow alert, first DMA channel 410 may write new data at the location indicated by head pointer 427 and overwrite data in buffer 420. First DMA channel 410 may output the overflow condition to other components in system 400 to prevent overwriting data. The overflow condition may be output as an interrupt signal.

First DMA channel 410 may determine an underflow condition when tail pointer 426 catches up to head pointer 427. First DMA channel 410 may additionally determine one or more underflow warnings in advance of an underflow alert. As one of various examples, first DMA channel 410 may define a “four locations remaining” underflow warning when only four memory locations are available before an underflow alert would be triggered. The “four locations remaining” underflow warning is not intended to be limiting, and an underflow warning may be determined based on another numerical value of locations remaining. Collectively, the underflow alert and underflow warnings may be termed underflow conditions. First DMA channel 410 may determine one or more underflow conditions.

During conditions of an underflow alert, second DMA channel 440 may read data at the location indicated by tail pointer 426 before first DMA channel 410 had written new data to buffer 420. First DMA channel 410 may output the underflow condition to other components in system 400 to prevent the reading of erroneous data. The underflow condition may be output as an interrupt signal.

The example illustrated in FIG. 4 includes 2 DMA channels, but this is not intended to be limiting.

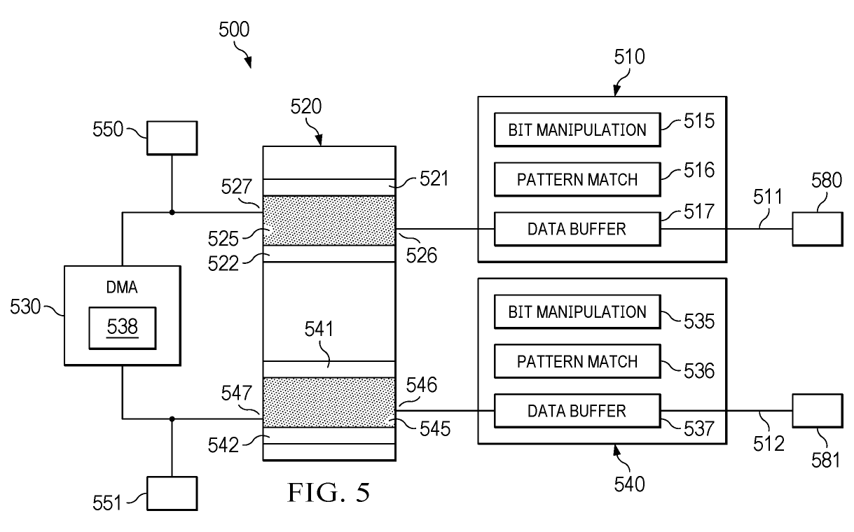

FIG. 5 illustrates a block diagram of a system 500 for peer-to-peer-to-peer data transmission utilizing multiple circular FIFOs.

System 500 may include a first DMA channel 510, a second DMA channel 530, third DMA channel 540 and buffer 520.

Buffer 520 may be configured to include a receive circular FIFO between a first location 521 and a second location 522. The size of the receive circular FIFO shown in FIG. 5 is for illustrative purposes and should not be taken as limiting. Buffer 520 may be configured to include a transmit circular FIFO between a third location 541 and a fourth location 542. The size of the transmit circular FIFO shown in FIG. 5 is for illustrative purposes and should not be taken as limiting.

Second DMA channel 530 may read data from receive circular FIFO and write data to transmit circular FIFO. Second DMA channel 530 may be a bus initiator and may initiate transfer of data to and from buffer 520.

First DMA channel 510 may include a bit manipulation circuit 515 , a pattern match circuit 516 and a receive data buffer 517. In operation, a peripheral 580 may write data to the receive data buffer 517 via path 511. First DMA channel 510 may be a bus initiator and may initiate transfer of data to buffer 520 and from peripheral 580. Peripheral 580 may generate a digital data stream.

Third DMA channel 540 may include a bit manipulation circuit 535, a pattern match circuit 536 and a transmit data buffer 537. In operation, third DMA channel 540 may write data from the transmit data buffer 545 to a peripheral 581. Third DMA channel 540 may be a bus initiator and may initiate transfer of data from buffer 520 and to peripheral 581.

First DMA channel 510 may include logic and other circuitry to track a receive head pointer 526. Receive head pointer 526 may contain the location that first DMA channel 510 may write the next data word from receive data buffer 157. Receive head pointer 526 may be stored in a head pointer register. First DMA channel 510 may include logic and other circuitry to track receive tail pointer 527. Receive tail pointer 527 may contain the location that second DMA channel 530 may read the next data word from buffer 520. Receive tail pointer 527 may be stored in a tail pointer register.

Second DMA channel 530 may include logic and other circuitry to track receive tail pointer 527. Receive tail pointer 527 may contain the location that second DMA channel 530 may read the next data word from buffer 520. Receive tail pointer 527 may be stored in a tail pointer register. Second DMA channel 530 may include logic and other circuitry to track a transmit head pointer 547. Transmit head pointer 547 may contain the location that second DMA channel 530 may write the next data word from data buffer 538. Transmit head pointer 547 may be stored in a transmit head pointer register.

Third DMA channel 540 may include logic and other circuitry to track a transmit head pointer 547. Transmit head pointer 547 may contain the location that second DMA channel 530 may write the next data word from data buffer 538. Transmit head pointer 547 may be stored in a transmit head pointer register. Third DMA channel 540 may include logic and other circuitry to track transmit tail pointer 546. Transmit tail pointer 546 may contain the location that third DMA channel 540 may read the next data word from buffer 520. Transmit tail pointer 546 may be stored in a tail pointer register.

The region between transmit head pointer 547 and transmit tail pointer 546 may indicate valid data, as shown by region 545 in FIG. 5. The region between receive head pointer 526 and receive tail pointer 527 may indicate valid data, as shown by region 525 in FIG. 5.

In operation, peripheral 580 may write data receive data buffer 517 in first DMA channel 510 via path 511. First DMA channel 510 may write data from receive data buffer 517 to a location in buffer 520 specified by receive head pointer 526. Second DMA channel 530 may read data from buffer 520 at the location specified by receive tail pointer 527 and may store the data in data buffer 538. Second DMA channel 530 may write data from data buffer 538 to a location in buffer 520 specified by transmit head pointer 547. Third DMA channel 540 may read data from buffer 520 at the location specified by transmit tail pointer 546. Third DMA channel 540 may store data in transmit data buffer 537 and may write data to peripheral 581 via path 512.

First DMA channel 510 may determine a receive overflow condition when receive head pointer 526 catches up to receive tail pointer 527. First DMA channel 510 may additionally determine one or more receive overflow warnings in advance of a receive overflow alert. As one of various examples, first DMA channel 510 may define a “four locations remaining” receive overflow warning when only four memory locations are available before a receive overflow alert would be triggered. The “four locations remaining” receive overflow warning is not intended to be limiting, and a receive overflow warning may be determined based on another numerical value of locations remaining. Collectively, the receive overflow alert and receive overflow warnings may be termed receive overflow conditions. First DMA channel 510 may determine one or more receive overflow conditions.

During conditions of a receive overflow alert, first DMA channel 510 may write new data at the location indicated by receive head pointer 526 and overwrite data in buffer 520. First DMA channel 510 may output the receive overflow condition to other components in system 500 to prevent overwriting data. The receive overflow condition may be output as an interrupt signal.

First DMA channel 510 may determine a receive underflow condition when receive tail pointer 527 catches up to receive head pointer 526. First DMA channel 510 may additionally determine one or more receive underflow warnings in advance of a receive underflow alert. As one of various examples, First DMA channel 510 may define a “four locations remaining” receive underflow warning when only four memory locations are available to be read before a receive underflow alert would be triggered. The “four locations remaining” receive underflow warning is not intended to be limiting, and a receive underflow warning may be determined based on another numerical value of locations remaining.

During conditions of a receive underflow alert, second DMA channel 530 may read data at the location indicated by receive tail pointer 527 before first DMA channel 510 had written new data to buffer 520. First DMA channel 510 may output the receive underflow condition to other components in system 500 to prevent the reading of erroneous data. The receive overflow condition may be output as an interrupt signal.

Third DMA channel 540 may determine a transmit overflow condition when transmit head pointer 547 catches up to transmit tail pointer 546. Third DMA channel 540 may additionally determine one or more transmit overflow warnings in advance of a transmit overflow alert. As one of various examples, third DMA channel 540 may define a “four locations remaining” transmit overflow warning when only four memory locations are available before a transmit overflow alert would be triggered. The “four locations remaining” transmit overflow warning is not intended to be limiting, and a transmit overflow warning may be determined based on another numerical value of locations remaining. Collectively, the transmit overflow alert and transmit overflow warnings may be termed receive overflow conditions. Third DMA channel 540 may determine one or more transmit overflow conditions.

During conditions of a transmit overflow alert, second DMA channel 530 may write new data at the location indicated by transmit head pointer 547 and overwrite data in buffer 520. Third DMA channel 540 may output the transmit overflow condition to other components in system 500 to prevent overwriting data.

Third DMA channel 540 may determine a transmit underflow condition when transmit tail pointer 546 catches up to transmit head pointer 547. Third DMA channel 540 may additionally determine one or more transmit underflow warnings in advance of a transmit underflow alert. As one of various examples, Third DMA channel 540 may define a “four locations remaining” transmit underflow warning when only four memory locations are available to be read before a transmit underflow alert would be triggered. The “four locations remaining” transmit underflow warning is not intended to be limiting, and a transmit underflow warning may be determined based on another numerical value of locations remaining.

During conditions of a transmit underflow alert, third DMA channel 540 may read data at the location indicated by transmit tail pointer 546 before second DMA channel 530 had written new data to buffer 520. Third DMA channel 540 may output the transmit underflow condition to other components in system 500 to prevent the reading of erroneous data.

First DMA channel 510 , second DMA channel 530 and third DMA channel 540 may be part of a single DMA controller circuit.

The example illustrated in FIG. 5 includes 3 DMA channels, but this is not intended to be limiting.

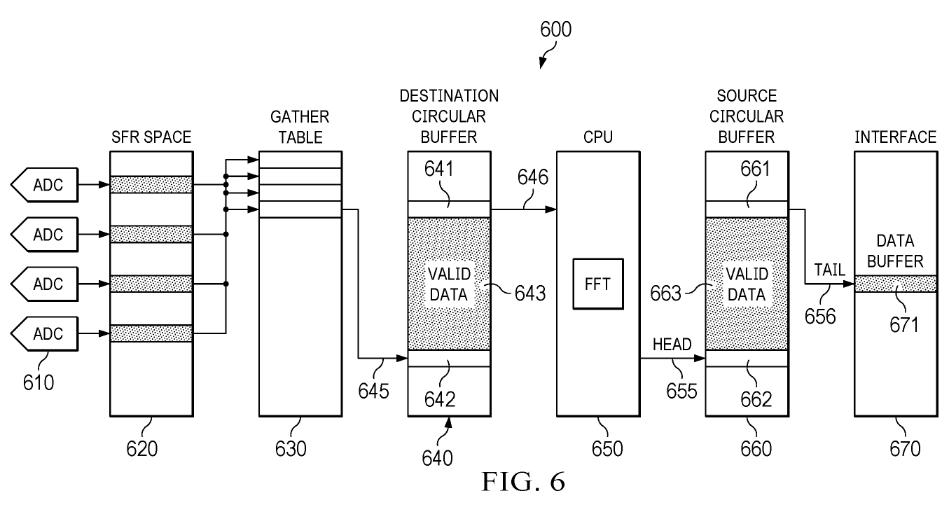

FIG. 6 illustrates a block diagram of a system 600 for a receive and transmit DMA data operation in a data acquisition application utilizing one or more circular FIFOs.

One or more peripherals 610 may generate data and may write data to scatter-gather register space 620. The example illustrated in FIG. 6 includes peripherals comprising 4 analog-to-digital converters (ADCs), but this is not intended to be limiting. Other examples may include more or fewer peripherals. Examples of peripherals 610 include, but are not limited to, communication interfaces such as Universal Asynchronous Receiver-Transmitter (UART), Serial Peripheral Interface (SPI), Inter-Integrated Circuit (I²C), Controller Area Network (CAN), or Universal Serial Bus (USB) modules; timing components such as timers, counters, or pulse-width modulation (PWM) units; analog interfaces such as analog-to-digital converters (ADCs) or digital-to-analog converters (DACs); and control interfaces for external devices such as motor drivers, display controllers, or general-purpose input/output (GPIO) ports. Peripherals in system 600 may be all of the same type, or may be of different types.

Scatter-gather register space may be a non-transitory memory. Data may be written from scatter-gather register space 620 to gather table 630. Gather table 630 may collect data from disparate memory locations in scatter-gather register space 620 into a single contiguous memory space within gather table 630. Gather table 630 may be a non-transitory memory.

Destination circular buffer 640 may be configured to include a circular buffer between a first location 641 and a second location 642. Source circular buffer 660 may be configured to include a circular buffer between a first location 661 and a second location 662.

The DMA controller may initiate data transfer from gather table 630 to destination circular buffer 640 at the location specified by destination head pointer 645. CPU 650 may initiate data transfer from the location in destination circular buffer 640 specified by destination tail pointer 646. CPU 650 may execute one or more operations on the data transferred from destination circular buffer 640. The example illustrated in FIG. 6 shows a fast Fourier transform (FFT) operation performed in CPU 650, but this is not intended to be limiting. CPU 650 may execute other operations or algorithms on the data transferred from destination circular buffer 640. The region between destination head pointer 645 and destination tail pointer 646 may indicate valid data, as shown by region 643 in FIG. 6.

CPU 650 may initiate a data transfer from CPU 650 to the source circular buffer 660 at the location specified by the source head pointer 655. A DMA controller in interface 670 may initiate a data transfer from the source circular buffer 660 at the memory location specified by the source tail pointer 656 to a data buffer 671 in interface 670. The region between source head pointer 655 and source tail pointer 656 may indicate valid data, as shown by region 663 in FIG. 6.

As one of various examples, data be input from a peripheral at first sample rate, data may be processed in the CPU, and data may be written to an interface at a second sample rate. Sample rate conversion operations may be implemented in CPU 650 to ensure no loss of data occurs during the transfers.

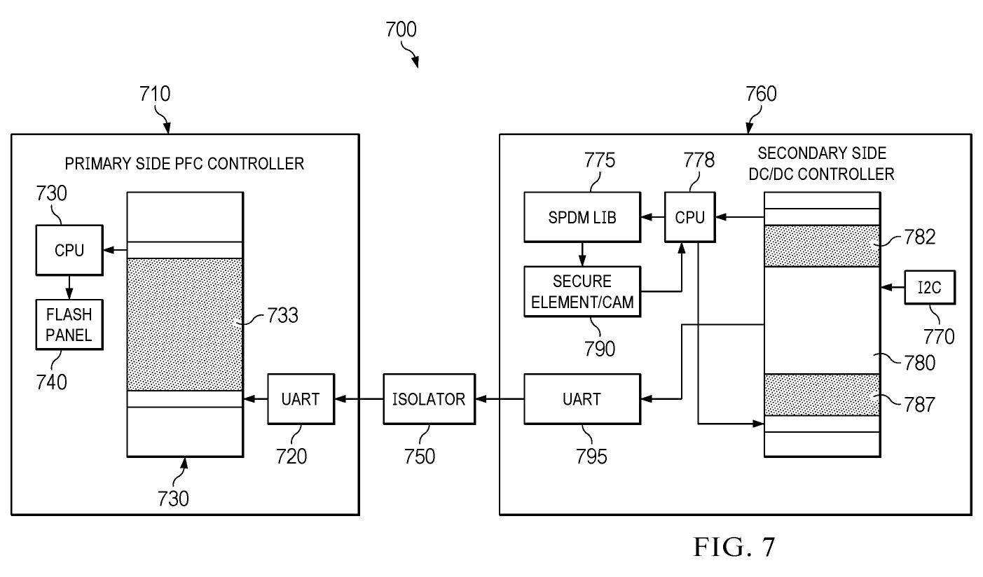

FIG. 7 illustrates a block diagram of a system 700 to receive and transmit data in a secure boot application utilizing one or more circular FIFOs.

System 700 may include a power factor correction (PFC) controller 710, an isolator 750 and a direct-current (DC)-DC controller 760. PFC controller 710 and DC-DC controller 760 may be an integrated silicon component, or may be separate silicon components. Memory 780 may be configured as a first circular buffer 782 and a second circular buffer 787.

In operation, DC-DC controller 760 may receive a data transmission at I2C transceiver 770. I2C transceiver 770 may write the received data into a first circular buffer within memory 780. CPU 778 may pull data from the first circular buffer and may write the data back to a second circular buffer. Universal Asynchronous Receiver-Transmitter (UART) 795 may pull data from second circular buffer 787 and write the data to isolator 750. DC-DC Controller 760 may include Security Protocol and Data Model (SPDM) Library 775 and Secure Element Content Addressable Memory (CAM) 790. In one of various examples, DMA channel may move data from memory 780 to UART 795.

UART 720 in PFC Controller 710 may receive data from isolator 750. A DMA controller may write data to a circular buffer 733 in memory 730. CPU 735 may read data from the circular buffer in memory 730 and may write the data to a flash memory panel 740.

In this manner, system 700 may implement a secure boot sequence, with a boot image sent over a PMBus to I2C transceiver 770 and send to PFC controller 710 via isolator 750. DC-DC controller 760 may support multi-device firmware updates via an incoming image sent over I2C and forwarded to PFC controller 710 via UART 795 and UART 720.

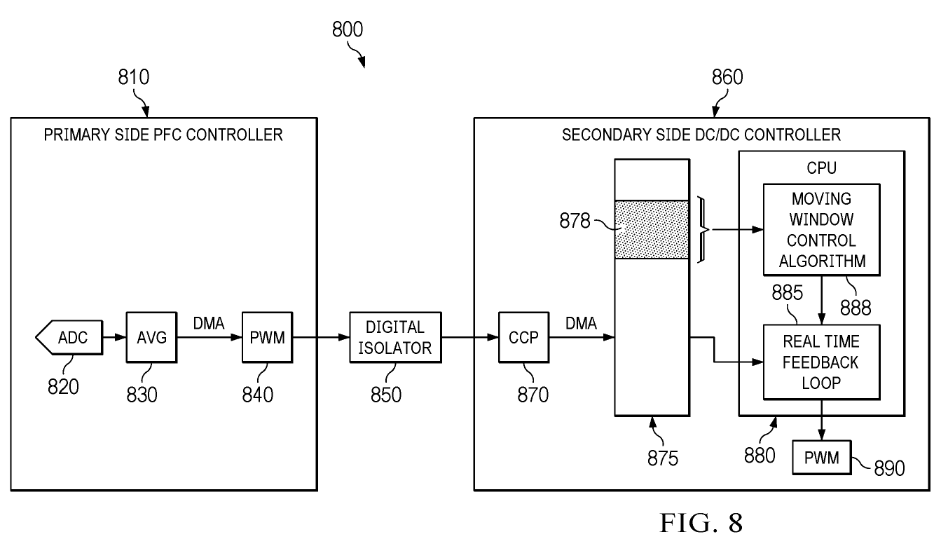

FIG. 8 illustrates a block diagram of a system 800 to receive and transmit DMA data operation in a real-time control system application utilizing one or more circular FIFOs.

System 800 may include PFC controller 810, isolator 850, and DC-DC Controller 860.

PFC controller 810 may include ADC 820. ADC 820 may convert an analog signal to a digital representation and averaging circuit 830 and PWM modulator 840 may convert the digital representation to a duty cycle. ADC 820 may convert a power supply voltage, a sensor output or another type of analog voltage not specifically mentioned. A DMA controller may move data between averaging circuit 830 and PWM modulator 840. PWM modulator 840 may output a duty cycle to isolator 850, and isolator 850 may output the duty cycle to DC-DC controller 860.

The output of isolator 850 may be input to capture and compare module (CCP) 870. The CCP 870 may convert the duty cycle representation to a numerical value and a DMA controller may write the converted duty cycle representation into a circular buffer 878 within memory 875. CPU 880 may pull a duty cycle value from the circular buffer and may input the duty cycle into real-time feedback loop 885. CPU 880 may also compute a moving average of the duty cycle at moving window control algorithm 888. The moving average may be input to real-time feedback loop 885. The real-time feedback loop 885 may utilize both the current duty cycle read directly from the circular buffer, and the moving average value from moving window control algorithm 888 to generate an input to PWM modulator 890.

System 800 may be part of a resonant converter, a switching converter or another type of power converter.

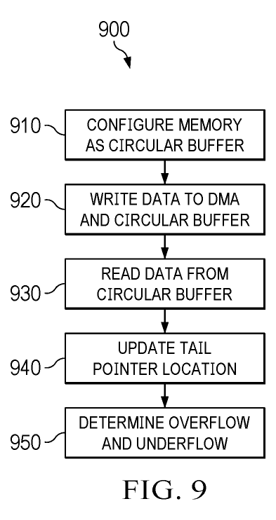

FIG. 9 illustrates a flow chart of a method of data management in a circular FIFO in hardware and software.

At operation 910, a memory may be configured as a circular buffer with a head pointer and a tail pointer. The memory configuration may be performed in software by a microcontroller or other device coupled to the memory.

At operation 920, in hardware, a peripheral may write data into a DMA controller, and the DMA controller may write the data into the circular buffer at the location specified by the head pointer. The DMA controller may subsequently update the head pointer.

At operation 930, in software, a CPU may read data from the circular buffer at the location specified by the tail pointer.

At operation 940, in software, the CPU may update the DMA with the current location of at least one of the tail pointer and the head pointer. In receive operations, the tail pointer may be updated. In transmit operations, the head pointer may be updated.

At operation 950, in hardware, the DMA controller may determine at least one overflow condition and at least one underflow condition based on the tail pointer and the head pointer. The at least one overflow condition may be at least one of an overflow alert and an overflow warning. The at least one underflow condition may be at least one of an underflow alert and an underflow warning.

Although examples have been described above, other variations and examples may be made from this disclosure without departing from the spirit and scope of these disclosed examples.

1. A device comprising:
a first bus initiator coupled to a peripheral, wherein the first bus initiator comprises a data buffer, a head pointer register and a tail pointer register, the data buffer to receive a data stream from the peripheral;
a non-transitory memory coupled to the first bus initiator and configured as a circular buffer; and
a second bus initiator coupled to an output of the non-transitory memory,
wherein the first bus initiator to write data from the data buffer to the non-transitory memory at a memory location specified by a content of the head pointer register and the second bus initiator to read data from the non-transitory memory at a memory location specified by a content of the tail pointer register.

2. The device as claimed in claim 1, wherein the first bus initiator comprises a first direct memory access (DMA) channel configured by a DMA controller.

3. The device as claimed in claim 2, wherein the second bus initiator comprises a second DMA channel configured by the DMA controller.

4. The device as claimed in claim 1, wherein the second bus initiator comprises a central processing unit (CPU).

5. The device as claimed in claim 1, wherein the first bus initiator is to compute an amount of data in the circular buffer based on the content of the head pointer register and the content of the tail pointer register.

6. The device as claimed in claim 1, wherein the first bus initiator is to compute one or more overflow conditions based on the content of the head pointer register and the content of the tail pointer register, the one or more overflow conditions comprising at least one of an overflow alert and an overflow warning.

7. The device as claimed in claim 6, wherein the first bus initiator is to generate an interrupt signal based on the overflow condition.

8. The device as claimed in claim 1, wherein the first bus initiator is to compute one or more underflow conditions based on a content of the head pointer register and a content of the tail pointer register, the one or more underflow conditions comprising at least one of an underflow alert and an underflow warning.

9. The device as claimed in claim 8, wherein the first bus initiator is to generate an interrupt signal based on the underflow condition.

10. The device as claimed in claim 1, wherein the second bus initiator is to write data to the non-transitory memory at the location specified by a content of the head pointer register and the first bus initiator to read data from the non-transitory memory at the location specified by a content of the tail pointer register.

11. The device as claimed in claim 1, wherein the second bus initiator is to update a content of at least one of the head pointer register and the tail pointer register.

12. The device as claimed in claim 1, comprising a bus snooper circuit coupled to an output of the non-transitory memory, the bus snooper circuit to update a content of the tail pointer register based on the output of the non-transitory memory.

13. A system comprising:
a direct memory access (DMA) controller to receive a digital data stream, the DMA controller comprising a receive data buffer and a transmit data buffer;
a non-transitory memory coupled to the DMA controller comprising:
a receive circular buffer and transmit circular buffer,
a bus initiator to read data from the receive circular buffer at a location specified by a content of a receive tail pointer register and to write data to the transmit circular buffer at a location specified by a content of a transmit head pointer register,
wherein the direct memory access (DMA) controller to write data from the receive data buffer to the receive circular buffer at a location specified by a content of a receive head pointer register and to read data from the transmit circular buffer at a location specified by a content of a transmit tail pointer register.

14. The system as claimed in claim 13, wherein the DMA controller to transfer data to and from the receive circular buffer and to transfer data to and from the transmit circular buffer.

15. The system as claimed in claim 14, wherein the DMA controller is to compute at least one receive overflow condition and at least one receive underflow condition based on a content of the receive head pointer register and a content of the receive tail pointer register, the at least one receive overflow condition comprising at least one of a receive overflow alert and a receive overflow warning, and the at least one receive underflow condition comprising at least one of a receive underflow alert and a receive underflow warning.

16. The system as claimed in claim 14, wherein the DMA controller is to compute at least one transmit overflow condition and at least one transmit underflow condition based on a content of the transmit head pointer register and a content of the transmit tail pointer register, the at least one transmit overflow condition comprising at least one of a transmit overflow alert and a transmit overflow warning, and the at least one transmit underflow condition comprising at least one of a transmit underflow alert and a transmit underflow warning.

17. A method comprising:
configuring a non-transitory memory as a circular buffer;
writing data from a peripheral to a first bus initiator and writing the data from the first bus initiator to the circular buffer, at a location specified by a content of a head pointer register;
reading, by a second bus initiator, data from the circular buffer at a location specified by a content of a tail pointer register;
updating, by the second bus initiator, a content of the tail pointer register; and
calculating, by the first bus initiator, an overflow condition and an underflow condition based on a content of the tail pointer register and a content of the head pointer register.

18. The method as claimed in claim 17, wherein the first bus initiator comprises a first direct memory access (DMA) channel configured by a DMA controller.

19. The method as claimed in claim 18, wherein the second bus initiator comprises a second DMA channel configured by the DMA controller.

20. The method as claimed in claim 17, wherein the second bus initiator comprises a central processing unit (CPU).
